(19) United States
(12) Patent Application Publication
(10) Pub. No.: US 2015/0114720 A1
(43) Pub. Date: Apr. 30, 2015

(54) Inhibition of Microfissure Formation in Wear Resistant Coatings

(71) Applicant: SMITH INTERNATIONAL, INC., Houston, TX (US)

(72) Inventors: Robert Ferguson, Humble, TX (US); Peter T. Cariveau, Houston, TX (US)

(21) Appl. No.: 14/522,124

(22) Filed: Oct. 23, 2014

Related U.S. Application Data
(60) Provisional application No. 61/895,325, filed on Oct. 24, 2013.

(51) Int. Cl. C21D 6/00; C21D 1/20; E21B 7/00; C23F 17/00; B23K 37/00; C21D 1/28; C23C 4/18

(52) U.S. Cl. CPC C21D 6/008; C21D 6/005; C21D 6/002; C21D 1/28; C21D 1/20; C23C 4/18; C23F 17/00; B23K 37/003; E21B 7/00; C21D 2211/001; C21D 2211/002
USPC 175/92; 148/537; 148/528

(57) ABSTRACT

A method of manufacturing coated components, e.g., for use in downhole drilling, which may limit, during the manufacturing process, the formation of microfissures and other performance-inhibiting characteristics in the abrasion resistant coating. The method may include applying an abrasion resistant coating composition to a substrate. The abrasion resistant coating composition and at least the surface of the substrate may be heated to effect metallurgical bonding of the abrasion resistant coating composition with the substrate. The substrate may then be austempered under process conditions selected to limit the volume of expansion of the substrate during austempering to less than about 0.8%.

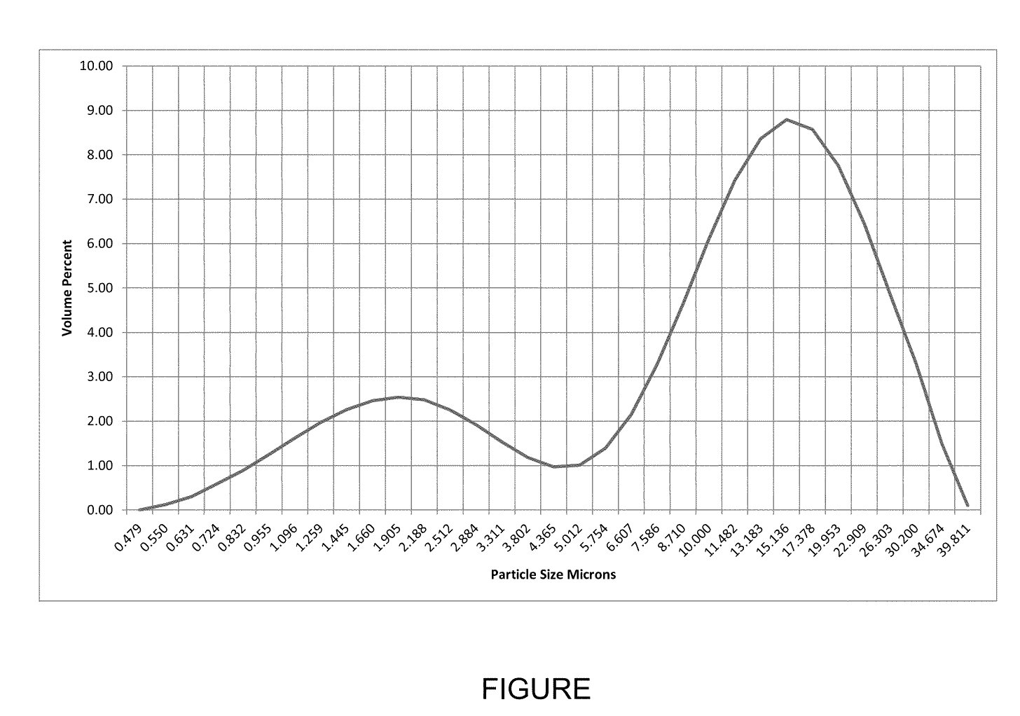

### CROSS-REFERENCE TO RELATED APPLICATIONS

This application claims the benefit of related U.S. Provisional Patent Application Ser. No. 61/895,325, filed on Oct. 24, 2013, the disclosure of which is incorporated by reference herein in its entirety.

### BACKGROUND

Directional drilling for the recovery of hydrocarbons or minerals from a subsurface formation may be enabled using a downhole motor (also commonly referred to as a “drilling motor” or “mud motor”), which is incorporated into the drill string above the drill bit. A downhole motor may include a rotor, a stator, a drive shaft and a bearing assembly, among other components.

During operation of the downhole motor, high-pressure drilling fluid may be used to power the motor. In addition to powering the motor, the drilling fluid (or drilling mud) provides hydrostatic pressure to prevent formation fluids from entering the wellbore; cools and lubricates drill string components and the drill bit; and lifts cuttings away from the drill bit, among other functions. Various drilling muds may be employed for specific purposes during drilling operations and they often contain corrosive chemicals and various sized particles to perform their intended task.

In recent years, downhole motors have been introduced with power sections (e.g., rotor within stator) that generate very high-torque. These include “even-wall” stators, such as the ERT series offered by Robbins & Myers, and hard rubber (HR) stators, such as those offered by Dyna-Drill. Higher torque results from the ability of these power sections to withstand higher operating pressures and pressure drops. The one or more bearings used in the universal joints as drive elements to transmit torque must endure high loads and a fretting motion, which create point contact and high Hertzian stresses that may cause the mating materials to yield or spall. Also, when used as thrust bearings, ball bearings and their mating thrust seats may suffer galling because the thrust balls must be relatively small, because they are positioned under, and in the same plane with, the drive elements. Spalling and galling are destructive occurrences that can lead to costly failure of the bearings, and thus, of the entire downhole motor.

### SUMMARY

In one implementation disclosed herein, a method for of manufacturing a component having an abrasion resistant coating is disclosed. The method may include applying an abrasion resistant composition to a metal surface of a substrate. The abrasion resistant composition and at least the surface of the substrate may be heated to effect metallurgical bonding of the abrasion resistant composition with the substrate. The substrate may be austempered under process conditions selected to limit the volume of expansion of the substrate during austempering to less than 0.8%.

In another implementation, a method of forming a component having an abrasion resistant coating is disclosed. The method may include brazing an abrasion resistant coating to a substrate. Heating the substrate to a temperature of greater than about 1650° F. Cooling the substrate to a temperature in a range from about 600° F. to about 675° F. The substrate temperature after cooling may then be maintained to be within a range from about 600° F. to about 675° F. for a selected period of time.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF DRAWINGS

The FIGURE is a chart illustrating a particle size distribution of an implementation of the abrasion resistant coatings disclosed herein.

### DETAILED DESCRIPTION

Numerous drill string components, including, e.g., universal joint bearings, may be exposed to high stress environments, often in the presence of corrosive and abrasive chemicals found in drilling muds and other fluids within a wellbore during drilling operations. These drilling components may be coated with an abrasive and corrosion resistant alloy to extend their useful lifetimes as well as minimize their failure under drilling conditions. Selecting the correct properties of the abrasive and corrosion resistant alloy is an important aspect for producing quality drilling components. It has also been found that the process used to apply a coating to a drilling component may additionally play an important role in the final properties of the resulting component.

One or more implementations disclosed herein relate to methods for forming or creating abrasion resistant coatings. These methods are useful for improving abrasive wear and corrosion resistance in radial bearings, tools, and downhole components exposed to drilling forces and abrasive and corrosive drilling fluids. These methods may further improve the crystalline structure of the base metal, decrease hoop stresses, and/or decrease micro fissure formation. The product of one or more of these methods is a coated drilling component with greater abrasion resistance and an improved operational lifetime under drilling conditions. Further, the methods or processes for forming abrasion resistant coatings disclosed herein may be useful with a wide variety of coating compositions. For example, coating compositions may include various metals (and alloys of one or more of the metals) including nickel, tungsten, cobalt, molybdenum, boron, titanium, chromium, and vanadium, among other Group 4 to Group 10 metals.

Abrasion resistant coatings according to implementations disclosed herein may be formed from a mixture of spherical tungsten cobalt carbide particles and tungsten carbide particles. The abrasion resistant coatings may include a plurality of spherical tungsten cobalt carbide particles and a plurality of tungsten carbide particles. In some implementations, the spherical tungsten cobalt carbide particles are spherically-shaped, plasma-densified tungsten cobalt carbide particles.

In forming the mixture, the plurality of particles used may be of varied sizes. For example, the particle size and/or the particle size distribution of the spherical tungsten cobalt carbide particles may be selected to result in coatings having excellent abrasion resistance, e.g., from decreased oxygen content or decreased mean free path, as will be discussed further below. While the tungsten cobalt carbide particles may be referred to herein as spherical, those skilled in the art will readily recognized that such particles may not all be exactly spherical and that the use of the spherical term incorporates particles that are generally spherically-shaped and may additionally include one or more particles that are irregularly-shaped.

In one or more implementations, less than about 5% by volume of the spherical tungsten cobalt carbide particles have a diameter of greater than about 35 microns. In other implementations, less than about 5% by volume of the particles have a diameter of greater than about 30 microns. In one or more implementations, less than about 30% by volume of the spherical tungsten cobalt carbide particles have a diameter of greater than about 25 microns. In other implementations, less than about 25%, less than about 20% or even less than about 15% by volume of the particles have a diameter of greater than about 25 microns. In one or more implementations, less than about 4% or even less than about 3% by volume of the spherical tungsten cobalt carbide particles have a diameter of greater than about 35 or 30 microns. In other implementations, less than about 2.5% or even less than about 2% by volume of the particles have a diameter of greater than about 35 or 30 microns. In yet other implementations, less than about 2% or even less than about 1% by volume of the particles have a diameter of greater than about 35 or 30 microns.

In addition to limiting the number of large particles used to form the coating, limiting the number of small spherical tungsten cobalt carbide particles used to form the coating may also be beneficial. In one or more implementations, less than about 5% by volume of the spherical tungsten cobalt carbide particles have a diameter of less than about 5 microns. In other implementations, less than about 5% by volume of the particles have a diameter of less than about 7 microns. In yet other implementations, less than about 5% by volume of the particles have a diameter of less than about 9 microns. In one or more implementations, less than about 3% by volume of the spherical tungsten cobalt carbide particles have a diameter of less than about 5, 7, or 9 microns. In other implementations, less than about 2.5% or even less than about 2% by volume of the particles have a diameter of less than about 5, 7, or 9 microns. In yet other implementations, less than about 1% by volume of the particles have a diameter of less than about 5, 7, or 9 microns. In some implementations, essentially no spherical tungsten cobalt carbide particles have a diameter of less than about 5 microns.

The particle size distribution of the spherical tungsten cobalt carbide particles is less than about 1.5 in some implementations, less than about 1.4 in other implementations; less than about 1.3 in other implementations; and less than about 1.2 in still other implementations. In one or more other implementations, the particle size distribution of the spherical tungsten cobalt carbide particles is less than about 1.1.

In some implementations, the spherical tungsten cobalt carbide particles have a particle size distribution having a D₅₀ (based on volume percent) in the range from about 12 to about 24 microns, such as a D₅₀ in the range from about 13 to about 20 microns or a D₅₀ in the range from about 14 to about 18 microns. In some implementations, essentially no spherical tungsten cobalt carbide particles have a diameter of less than about 5 microns and essentially no spherical tungsten cobalt carbide particles have a diameter of greater than about 38 microns.

When forming the coatings, the spherical tungsten cobalt carbide particles and the plurality of tungsten carbide particles may be used at a weight ratio of the spherical tungsten cobalt carbide particles to the plurality of tungsten carbide particles in the range from about 50:50 to about 90:10. In other implementations, the weight ratio of the spherical tungsten cobalt carbide particles to the plurality of tungsten carbide particles may be in the range from about 55:45 to about 88:12; and yet in other implementations, in the range from about 60:40, 65:35, or 70:30 to about 75:25 or 80:20.

By restricting the particle size of the spherical tungsten cobalt carbide particles as described above, the particles may have advantageously low initial oxygen content. In one or more implementations, prior to formation of the abrasion resistant coating, the spherical tungsten cobalt carbide particles may have an oxygen content of less than about 600 ppm by weight; less than 250 ppm by weight; less than 225 ppm by weight; or even less than 200 ppm by weight. Excessive oxygen may cause beading, for example, and may reduce the contact angle during the brazing (and sintering) process. For particle mixtures having high oxygen content, such as those having an oxygen content greater than 500 ppm or 600 ppm by weight, vacuum baking may be used to decrease the oxygen content to a more desirable range. Advantageously, selection of particle size distributions as detailed above may allow abrasion resistant coatings herein to be formed without a vacuum bakeout of the particles to decrease oxygen content, saving both time and operating expense. Further, elimination of a vacuum bakeout step may result in improved product consistency.

With regard to the tungsten carbide particles, the tungsten carbide particles may include at least one of monocrystalline tungsten carbide, cast tungsten carbide, macrocrystalline tungsten carbide, or a eutectic mixture of WC and W₂C. In some implementations, the tungsten carbide particles generally have a spherical shape. In other implementations, the tungsten carbide particles generally have an irregular spherical shape. While the tungsten carbide particles may be referred to herein as spherical or spherically-shaped, those skilled in the art will readily recognized that such particles may not all be exactly spherical and that the use of such spherical term incorporates particles that are generally spherically-shaped and may additionally include one or more particles that are irregularly-shaped.

An average particle size of the tungsten carbide particles is generally selected to be less than an average particle size of the spherical tungsten cobalt carbide particles. For example, the average particle size for the tungsten carbide particles may be in the range from about 0.1 to about 10 microns, such as in the range from a lower limit of about 0.5, 1, 1.5 2, 2.5, or 3 microns to an upper limit of about 1.5, 2, 2.5, 3, 3.5, 4, or 5 microns. In some implementations, an average particle size D₅₀ of the tungsten carbide particles may be less than about 10 microns and the tungsten carbide particles may have an average particle size D₅₀ in the range from about 1.2 to about 2.8 microns, such as in the range from about 1.4 to about 2 microns.

In one or more implementations, a particle size distribution of a mixture of the tungsten carbide particles and the spherical tungsten cobalt carbide particles is bimodal. For example, the particle size distribution of the mixture of tungsten carbide particles and the spherical tungsten cobalt carbide particles may be similar to that as illustrated in the FIGURE. Overall, the mixture may be selected such that greater than 95% of the particles have a particle size of less than about 35, 30, or 25 microns in various implementations.

The spherical powders and the size ranges used in one or more implementations disclosed herein may allow for improved flow and particle packing during the pucking or spraying processes as well as the brazing processes. The bimodal particle size distributions in one or more implementations disclosed herein may allow for the small irregular tungsten carbide particles to fill the large pores left by the larger spherical tungsten cobalt carbide particles. Limiting the maximum particle size may thus improve wear resistance by removing weak particles that may fracture and cause defects in the material. Further, limiting the large particles significantly improves the uniformity and packing of the particles, and may allow a larger percentage of the tungsten cobalt carbide material to be added to the matrix mixture without disrupting the particle packing and wear resistance. Overall, this leads to a much higher density tungsten cobalt carbide reinforced material.

Restricting the particle size distribution and the maximum particle size of the spherical tungsten cobalt carbide particles may result in a decrease in the mean free path for the braze infiltrate as compared to mixtures including any significant quantity of particles greater than about 35 microns in size. In other words, the particle size selection may restrict the mean free path between carbide particles and sintered masses of carbide. The resulting reduction in mean free path, as compared to mixtures including larger particles, may result in improved abrasive resistance, thereby reducing the rate at which erosion and abrasive wear may occur. The presence of a larger mean free path and braze accumulation will result in erosion and abrasive wear at a much faster rate than adjacent carbide masses. Further, the use of spherical tungsten cobalt carbide particles may reduce the localized stress concentration at the surface of sintered masses. Thus, proper selection of particle size and particle size distribution according to one or more implementations disclosed herein may provide for superior abrasion resistant coatings.

In some implementations, the abrasion resistant coating has a mean free path, as measured using image analysis and Scanning Electron Microscopy (SEM), between spherical tungsten cobalt carbide particles of less than about 15 microns. In other implementations, the abrasion resistant coating has a mean free path between spherical tungsten cobalt carbide particles of less than about 10 microns, less than about 9 microns, less than about 8 microns, less than about 7 microns, less than about 6 microns, and/or less than about 5 microns. In yet other implementations, the abrasion resistant coating has a mean free path between spherical tungsten cobalt carbide particles of less than about 4, 3, or even 2 microns.

As noted above, vacuum baking of the particles may be used to reduce average particle oxygen content. Heating of the particles during vacuum baking may result in sintering of some particles, which negatively impacts mean free path. Mean free path may thus advantageously be improved by proper selection of particle size and particle size distributions according to one or more implementations disclosed herein.

The mixture of particles described above may be used to form abrasion resistant coatings having an abrasive resistance factor of at least 135 for rotating components and at least 150 for nonrotating components. The abrasion resistance factor (ARF) may be determined by measuring the weight loss of the coating according to ASTM G65 method A and the density of the coating according to ASTM B311. The weight loss is converted to a volume loss by dividing the weight loss by the density of the coating. This volume loss is adjusted to account for diameter change of the rubber wheel during the test. The abrasive resistance factor is then calculated by taking the inverse of the adjusted volume loss times 1000. Abrasion resistant coatings, according to one or more implementations disclosed herein, may have an ARF of at least 135; an ARF of at least 150; an ARF of at least 160; an ARF of at least 170; an ARF of at least 180; an ARF of at least 190; and/or an ARF of at least 200. Abrasion resistant coatings, according to one or more implementations disclosed herein, may have an ARF in the range from about 110 to about 170, in the range from about 160 to about 220 and/or in the range from about 175 to about 200.

Production of spherical tungsten cobalt carbide particles may result in particles outside of the desired range of particles described above. In some implementations, spherical tungsten cobalt carbide particles may be sieved, ultrasonically sieved, or air classified to result in the desired particle size range and particle size distribution.

The abrasion resistant coatings described above may be applied to a drilling component, such as a radial bearing, to form a coated drilling component for use in drilling or other operations, e.g., such as those that may be performed downhole. For example, the abrasion resistant coatings described above may be applied to a wear surface of a radial bearing or other portions of a drilling component to provide a drilling component that has abrasion and wear resistance.

To facilitate application of the abrasion resistant coatings, the tungsten carbide particles and the spherical tungsten cobalt carbide particles, may be pre-mixed and/or milled with a ball mill, shaker-mixer (e.g., a TURBULA), or other means. The mixture of particles may then be joined together to form a puck; for example, the pucking process may include joining the particles together by a web-like structure formed by one or more polymeric materials, such as polytetrafluoroethylene (PTFE).

The resulting puck may then be milled into a thin flexible membrane or cloth. The thickness of the cloth selected may vary depending upon the underlying substrate, such as an iron metal or alloy, among others, as well as the depth of capillary action of the braze infiltrate to the selected underlying substrate. The flexible cloth may then be applied to a substrate and may readily conform to the shape of the substrate. The cloth may then be cut to shape and applied with a low temperature adhesive, if desired. Another cloth, such as a cloth containing a braze material powder, may then be applied onto the layer of cloth formed, according to one or more implementations disclosed herein.

Once the cloth layer(s) are applied, the temperature of the cloth layers and the surface of the substrate may be increased to brazing temperatures to effect the metallurgical bonding of the cloth layer(s) with the substrate material. The infiltration brazing process may be performed, for example, using a vacuum furnace with an inert gas atmosphere to preclude degradation of carbides at brazing temperatures, which may occur in the range from about 500° C. to about 1200° C. The brazed product may then be ground to produce a controlled finish without abuse of the abrasion resistant coating.

Alternatively, a method for manufacturing a downhole component may include applying, e.g., by HVAF thermal spraying, an abrasion resistant coating composition blended with a braze alloy to the metal substrate at a high particulate velocity (e.g., about 800 to about 1,100 meters per second) and a temperature of about 2,600° F. to about 2,900° F. A blend of about 30% braze alloy and about 70% coating composition has been found to provide an ARF of about 110 whereas a blend of about 20% braze alloy and about 80% coating composition has been found to provide an ARF of about 150. Thus, the ARF of the coated substrate increases as the percentage of braze alloy in the thermally sprayed blend decreases. Prior to application of the coating via thermal spraying, the metal substrate may or may not be heat treated (e.g., austempered or marquenched/tempered) above a temperature or temperature range that provides the metal substrate with its required mechanical properties and hardness. If the coating is applied after heat treatment of the metal substrate, then the coating may be heated rapidly above the liquidus temperature of the braze (e.g., by inductive heating) and held for a period of time to effect capillary flow of the braze thereby forming a metallurgical bond with the metal substrate without raising the metal substrate temperature above about 300° F. Such period of time may be greater than about 10 minutes but less than about 20 minutes, or anytime therebetween. A temperature over about 300° F. has been found to result in the substrate undergoing an additive secondary tempering cycle. If the coating is applied prior to the heat treatment of the metal substrate, heat treatment of the complete component (i.e., coating and metal substrate) may proceed after thermal spraying such that the residual stress in the coating may be reduced. The residual stress may be reduced by following one or more of the implementations described hereinafter.

The brazing process may result in a change in physical properties of the underlying metal substrate, such as when cloth layer(s) are used as described above (i.e., due to the brazing temperature). In one or more implementations, the brazed product may be heat treated to restore the grain structure and mechanical properties of the substrate altered by the elevated temperatures during brazing.

Heat treatment after application of the wear resistant coating may be performed to conform to various design criteria. One heat treatment that may be employed is a marquench and temper process. However, it has been found that such heat treatment process may be unsuitable for coatings to be used in a drilling environment. For example, marquench and temper processes (martensitic transformations) have been found to result in hoop stresses that exceed the ductility of the coating, thereby resulting in cracks in the coating and providing entrance features that may result in galvanic corrosion, pitting corrosion, crevice corrosion and otherwise more rapid destruction of the underlying metal component. These cracks or microfissures result in a lifespan less than what the underlying metal component would otherwise provide. Further, the martensitic structure of the underlying metal component has been found to continue to temper at downhole conditions, e.g., at temperatures greater than about 300° F., undesirably resulting in properties of the components degrading over time during downhole use.

Design criteria may contemplate the aforementioned corrosion, which creates stress risers in the underlying metal component (e.g., steel substrate) and changes the component properties during use and may thus reduce the stated load carrying capacity of the component. However, as previously noted, coated components are needed and desired that provide useful lifespans at the increased loads provided by recently developed drilling motors.

Implementations herein, and as described in more detail below, provide for a heat treatment process that may reduce or eliminate cracking of the wear coating, reduce or eliminate formation of microfissures, and/or lower the distortion of the underlying metal component. Such implementations facilitate improved process control and formation of components having superior wear, corrosion, and abrasion resistance. These advantages are believed to result from the reduced migration of corrodents to the steel or other metal substrate and associated formation of stress risers that have been found to be a primary cause of component failure as well as formation of a structure that does not continue to temper at downhole conditions.

A method of manufacturing a downhole component, according to one or more implementations herein, may include a first step of applying a layer of an abrasion resistant composition to a metal surface of a substrate (e.g., via cloth or thermal spray). In one or more implementations, the substrate may include a steel, low alloy steel or a stainless steel that may or may not use precipitation hardening. In at least one implementation, the substrate is an AISI 4140-type steel having less than about 0.01 wt. % sulfur and less than about 0.01 wt. % phosphorous.

One or more implementations of the method may include, prior to brazing, the formation of a cloth of the abrasion resistant coating composition. For example, the method may include, prior to brazing: pucking an abrasion resistant coating composition to form a puck; milling the puck to form a cloth; applying the cloth including the abrasion resistant coating composition to the substrate. In one or more implementations, the cloth may be adhered to the substrate using an adhesive compound. Another cloth, having a braze material powder, may be applied to at least one of the substrate and the cloth. In one or more other implementations of the method, as previously disclosed, an abrasion resistant coating composition and braze alloy blend may be thermally sprayed via HVAF onto the surface of the substrate. Such thermal spraying may be conducted after heat treatment of the metal substrate or prior thereto. If the blend is applied by thermal spray prior to metal substrate heat treatment, then the coated substrate may be heat treated via austempering disclosed hereafter to reduce the residual stress to the coating.

The abrasion resistant composition and at least the surface of the substrate may then be heated to effect metallurgical bonding (i.e., brazing) of the abrasion resistant composition with the substrate, thereby forming a coated substrate. In one or more implementations, brazing may be performed under vacuum. Such vacuum brazing may be carried out under an inert atmosphere. For example, the temperature of the substrate and coating may be increased under vacuum or other conditions to a temperature of greater than 1650° F., such as greater than about 1750° F., greater than about 1800° F., greater than about 1850° F., or even greater than about 1900° F., to bond the abrasion resistant composition with the substrate. Subsequently, it is cooled to a range of about 200° F. to about 750° F. before being withdrawn from the furnace.

The coated substrate may then be austempered by first reheating to 1550° F. to 1650° F. using molten salt or other media to austenitize the steel substrate. The coated substrate is next ausquenched to a temperature at or above the martensite start temperature and held for an extended period of time. In some implementations, the selected ausquench temperature, at or slightly above the martensite start temperature, may include temperatures in the range from about 600° F. to about 900° F. In other implementations, the coated substrate may be cooled to a temperature in the range from about 600° F. to about 725° F. or 750° F., while in yet other implementations, the coated substrate may be cooled to a temperature in the range from about 600° F. to about 675° F. The cooled coated substrate may then be maintained within these temperature ranges for a selected period of time, such as for a length of time in the range from about 15 to about 120 minutes, e.g., from about 30 to about 45 or about 60 minutes in one or more implementations.

This sequence of process conditions (i.e., austempering) has been selected to limit the volume of expansion of the coated substrate during austempering to less than about 0.8%, such as less than about 0.6%, less than about 0.5%, or even less than about 0.4%, as determined by differential dimension (dialometric) analysis. By selecting the conditions of time and temperature to limit volumetric expansion of the composition, microfissures and cracks in the coating of the component, such as those that form as a result of a marquench and temper process, may be substantially reduced or even eliminated. The volumetric expansion determined by differential dimension (dialometric) studies has been found to be impacted by the homogeneous distribution of carbon and other elements at lattice and/or vacancy sites in the steel in conjunction with uniformity of heat removal during the ausquench operation. It should be noted that heat removal is affected by the shape of the part, quench media and agitation of the same.

In some implementations, the process may also include normalizing the coated substrate prior to austempering. For example, the coated substrate may be heated to a temperature in the range from about 1550° F. to about 1650° F. and held at that temperature for a selected time period to austenitize the steel (e.g., about 15 minutes to about 60 minutes). The coated substrate is then cooled (e.g., to a temperature in a range of about 600° F. to about 900° F.) in fast moving air, or controlled atmosphere, to normalize and convert the grain size of the composition. It should be noted that multiple cycles may be necessary dependent on the response of the steel or other metal, e.g., due to its lack of homogenous composition. For instance, following brazing, the coated substrate may have an ASTM E112 grain size in the range from about 2/in² to about 4/in². The normalizing process conditions of time and temperature selected may convert the coated substrate to a structure having an ASTM E112 grain size in the range from about 6/in² to about 10/in², such as in the range from about 7/in² to about 10/in² or about 8/in² to about 9/in².

The normalizing process may be performed in one or more steps and may be performed under vacuum (i.e., vacuum normalization). In one or more implementations, the normalizing step is a double vacuum normalization, which may include: maintaining the coated substrate at a temperature in the range from about 1550° F. to about 1650° F. for a first period of time; cooling the coated substrate to a temperature of less than about 1550° F. and maintaining at that temperature for a second period of time; and heating to and maintaining the coated substrate at a temperature in the range from about 1550° F. to about 1650° F. for third period of time. In one or more implementations, the first, second, and third periods of time are each in the range from about 15 minutes to about 90 minutes, e.g., in the range from about 30 to about 45 or about 60 minutes.

The normalized coated substrate may be cooled to a temperature in a range from about 600° F. to about 900° F. to form a cooled coated substrate. In other implementations, the normalized coated substrate may be cooled to a temperature in the range from about 600° F. to about 750° F., while in yet other implementations, the normalized coated substrate may be cooled to a temperature in the range from about 600° F. to about 675° F. Such cooling, e.g., may be performed in moving air. The cooled coated substrate may then be maintained within these temperature ranges for a selected period of time, such as for a length of time in the range from about 15 to about 120 minutes, e.g., from about 30 to about 45 minutes in one or more implementations.

Following the austempering process, the coated component may then be water washed at a temperature in the range from about 125° F. to about 195° F., e.g., a temperature in the range from about 150° F. to about 170° F. The washed coated substrate may then be air cooled prior to retrieving the component for subsequent operations performed prior to use downhole in association with or forming part of a drill string.

Abrasion resistant coatings according to one or more implementations disclosed herein may be used to enhance the wear resistance of components that are used in drilling or downhole operations, where such components may be exposed to drilling muds and other fluids containing abrasive and corrosive constituents. In some implementations, the abrasion resistant coatings as described above may be applied to radial bearings, thrust bearings, universal joints, and transmissions, among other such components.

Methods according to one or more implementations herein may thus also include drilling a wellbore in a subterranean formation with a drill string incorporating the downhole component, such as a drilling motor assembly including one or more parts formed from or operative with the downhole components having an abrasion resistant coating formed according to the methods described above. Processes according to one or more implementations disclosed herein may be used to produce downhole components having a tensile strength of at least 170 ksi and a yield strength of at least 155 ksi.

Although only a few example implementations have been described in detail above, those skilled in the art will readily appreciate that many modifications are possible in the example implementations disclosed herein without materially departing from them. Accordingly, all such modifications are intended to be included within the scope of this disclosure. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke means plus function treatment for any limitations of any of the claims herein, except for those in which the claim expressly uses the words ‘means for’ together with an associated function.

What is claimed:

1. A method of manufacturing a component having an abrasion resistant coating, comprising:
applying an abrasion resistant composition to a metal surface of a substrate;
heating the abrasion resistant composition and at least the metal surface of the substrate to effect metallurgical bonding of the abrasion resistant composition with the substrate;
austempering the substrate under process conditions selected to limit the volume of expansion of the substrate during austempering to less than 0.8%.

2. The method of claim 1, further comprising normalizing the substrate prior to the austempering step.

3. The method of claim 2, wherein the substrate has an ASTM E112 grain size in the range from about 2/in² to about 4/in², the process further comprising selecting normalizing conditions of time and temperature to convert the substrate to a structure having an ASTM E112 grain size in the range from about 6/in² to about 10/in².

4. The method of claim 1, wherein the substrate comprises AISI 4140-type steel having less than about 0.01 wt. % sulfur and less than about 0.01 wt. % phosphorous.

5. The method of claim 1, wherein the downhole component has a tensile strength of at least 170 ksi and a yield strength of at least 155 ksi.

6. The method of claim 1, wherein the abrasion resistant composition is blended with a braze alloy and applied to the metal surface of the substrate via a thermal spraying process.

7. A method of forming a component having an abrasion resistant coating, comprising:
brazing an abrasion resistant coating to a substrate;
heating the substrate to a temperature of greater than about 1650° F.;
cooling the substrate to a temperature in a range from about 600° F. to about 675° F.; and
maintaining substrate temperature after cooling to be within a range from about 600° F. to about 675° F. for a selected period of time.

8. The method of claim 7, further comprising, prior to cooling:
normalizing the substrate by maintaining the substrate at a temperature in the range from about 1550° F. to about 1650° F. for a first period of time to form a normalized substrate.

9. The method of claim 7, further comprising water washing the substrate at a temperature in the range from about 125° F. to about 195° F. and air cooling the washed substrate.

10. The method of claim 7, further comprising producing the downhole component having an abrasive resistant coating having an ASTM grain size of at least about 6/in².

11. The method of claim 7, wherein cooling the substrate is performed in moving air.

12. The method of claim 8, wherein the normalizing step is a double vacuum normalization comprising:
maintaining the substrate at a temperature in the range from about 1550° F. to about 1650° F. for the first period of time;
cooling the substrate to a temperature of less than about 1550° F. and maintaining at that temperature for a second period of time; and
heating and maintaining the substrate to a temperature in the range from about 1550° F. to about 1650° F. for third period of time.

13. The method of claim 12, wherein the first, second, and third periods of time are each in the range from about 15 minutes to about 90 minutes.

14. The method of claim 7, further comprising at least one of:
adhering a cloth comprising the abrasion resistant coating composition to the substrate using an adhesive compound; and
applying another cloth comprising a braze material powder to at least one of the substrate and the cloth.

15. The method of claim 7, further comprising, prior to brazing:
pucking an abrasion resistant coating composition to form a puck;
milling the puck to form a cloth; and
applying the cloth comprising the abrasion resistant coating composition to the substrate.

16. The method of claim 7, wherein brazing is performed under vacuum.

17. The method of claim 16, wherein the vacuum brazing is carried out under an inert atmosphere.

18. The method of claim 7, further comprising drilling a wellbore in a subterranean formation with a drill string incorporating the downhole component.

19. The method of claim 7, wherein the abrasion resistant coating is blended with a braze alloy and applied to the substrate via a thermal spraying process.

20. The method of claim 19, wherein brazing the abrasion resistant coating to the substrate occurs after maintaining substrate temperature after cooling to be within the range from about 600° F. to about 675° F. for the selected period of time.
